(19) United States
(12) Patent Application Publication
(10) Pub. No.: US 2009/0195171 A1
(43) Pub. Date: Aug. 6, 2009

(54) TEMPERATURE CONTROL SYSTEM FOR BACKLIGHT MODULE

(76) Inventors: Wei-Hao Huang, Changhua County (TW); Ming-Yen Yu, Taichung County (TW)

Correspondence Address: Joe McKinney Muncy, PO Box 1364, Fairfax, VA, 22038-1364, US

(21) Appl. No.: 12/026,426

(22) Filed: Feb. 5, 2008

(51) Int. Cl. H05B 41/16

(52) U.S. Cl. 315/252

(57) ABSTRACT

The present invention discloses a temperature control system for a backlight module, which applies to a backlight module with the light source quantity of the light-emitting module being increased to directly promote the brightness of LCD. The present invention can timely modulate the brightness of the light-emitting module to slow the temperature rising speed or gradually lower the temperature via the detection function of the thermistor and the PWM control of the control circuit. Thereby, the prevent invention can prevent from the malfunction of electronic elements or the decrease of service life caused by heat accumulation in the light-emitting module.

### FIELD OF THE INVENTION

The present invention relates to a temperature control system for a backlight module, particularly to a temperature control system, which can timely lower the brightness of a backlight module according to the detection result of a thermistor.

### BACKGROUND OF THE INVENTION

Liquid crystal is an orderly-arranged organic compound having the characteristics of a solid and a liquid. When liquid crystal is heated to a certain temperature, it becomes a transparent liquid. When liquid crystal is cooled to a certain temperature, it becomes a cloudy solid. Because of the abovementioned characteristics, the name “liquid crystal” is assumed. In a liquid crystal display (LCD), liquid crystal is enclosed in a glass casing. When an electric field is applied to liquid crystal, the orientation of liquid crystal molecules is changed, and the orientation change of liquid crystal molecules further varies the optical characteristic thereof. The applied electric field, in cooperation with a polarizer film, can determine the transparency and brightness of the pixels on the liquid crystal display.

Under an environment of sunlight or intense light, the colors of the liquid crystal display will be bleached or even invisible. As the intensity of the color light of the liquid crystal display is insufficient, the colors are covered by the scattered light or reflected light of the external light source. The liquid crystal display itself should have a brightness of at least 1000 cd/m² before it can overcome the problem that the image thereof is covered by environmental light.

Increasing the light sources of the backlight unit is the most direct way to promote the brightness of the liquid crystal display. If the backlight unit can cooperate with a high performance reflector film, a high performance bright enhance film and a high aperture ratio LCD panel to increase light efficiency, the brightness of LCD will be further upgraded.

However, light sources generate heat. The more the light sources, the more the heat generated. Further, the temperature of the LCD module will become higher and higher with the increasing turn-on duration of a backlight module. High temperature causes that contrast decreases or even that LCD crashes because electronic elements overheat.

Because the conventional LCD cannot handle the problem of high temperature, they usually adopt a brightness of about 300 cd/m² together with a transflective design, or adopt a reflective design without using any backlight unit, to overcome the reflected light of the external light source. However, the abovementioned methods decrease color number and lower color purity, which affects the quality of images. Besides, the products of the reflective design cannot work in an environment of insufficient lighting.

### SUMMARY OF THE INVENTION

The primary objective of the present invention is to modulate the brightness of light sources to prevent from heat accumulation when the quantity of light sources is increased to enhance the brightness of a backlight module lest high temperature lower the performance or shorten the lifetime of related materials and electronic elements so that the service life of an LCD module can be prolonged.

To achieve the abovementioned objective, the present invention proposes a temperature control system for a backlight module, which applies to a backlight module with the light source quantity of the light-emitting module being increased to directly promote the brightness of LCD. The temperature control system for a backlight module of the present invention comprises: a light-emitting module used to provide brightness for the backlight module; at least one thermistor used to detect the temperature of the backlight module; and a control circuit receiving the signals of the thermistor and controlling the brightness output of the light-emitting module to modulate the temperature of the backlight module so that the temperature rising speed slow down or the temperature gradually descend.

According to the present invention, the light-emitting module includes a plurality of LEDs (Light Emitting Diode) or CCFLs (Cold Cathode Fluorescent Lamp); the control circuit modulates the brightness of the backlight module via a PWM (Pulse Width Modulation) method.

According to the present invention, when the control circuit receives a thermistor resistance value lower than a reference value, the control circuit lowers the brightness of the light-emitting module; when the control circuit receives a thermistor resistance value higher than a reference value, the control circuit does not adjust the brightness of the light-emitting module but keeps on providing appropriate power for the light-emitting module to maintain the brightness of the light-emitting module.

For a backlight module with the light source quantity of the light-emitting module being increased to directly promote the brightness of LCD, the present invention can timely modulate the brightness of the backlight module to slow the temperature rising speed or gradually lower the temperature via the detection function of the thermistor and the PWM control of the control circuit. Thereby, the prevent invention can prevent from the malfunction caused by the heat accumulation and temperature rising in LCM (Liquid Crystal Display Module). Further, the present invention can also prevent from the high-temperature-induced performance downgrade and service life decrease of related materials and electronic elements.

### BRIEF DESCRIPTION OF THE DRAWINGS

FIG. 1 is a diagram schematically showing a temperature control system according to one embodiment of the present invention.

FIG. 2 is a flowchart of the control process of a temperature control system according to one embodiment of the present invention.

### DETAILED DESCRIPTION OF THE PREFERRED EMBODIMENTS

Below, the technical contents of the present invention will be described in detail in cooperation with embodiments. However, it should be understood that the embodiments are only to exemplify the present invention but not to limit the scope of the present invention.

Increasing light sources of the backlight unit is the most direct way to greatly promote the brightness of LCM. However, the more the light sources, the more the heat accumulated. Further, the longer the turn-on duration of the backlight unit, the higher the temperature of LCM. High temperature causes that contrast decreases or even that LCD crashes because electronic elements overheat.

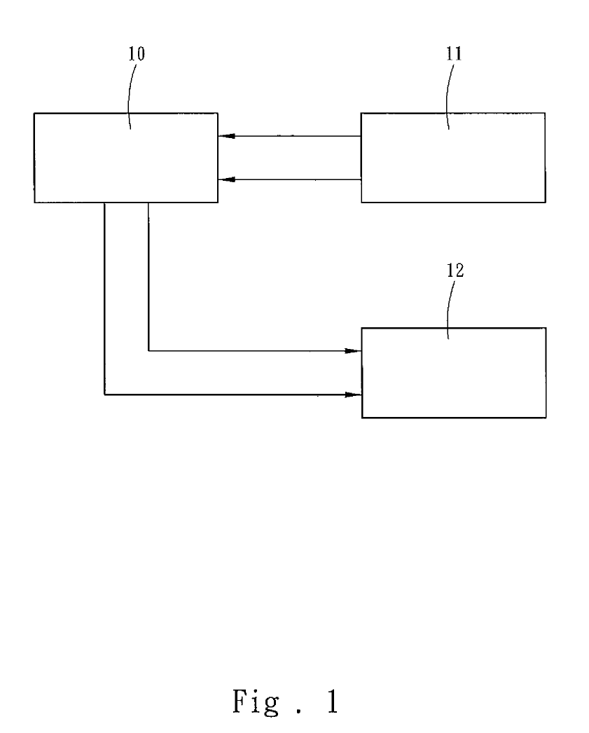

Refer to FIG. 1 for a temperature control system of a backlight module according to the present invention, which applies to the backlight module with the light source quantity thereof being increased to directly promote LCD brightness. The temperature control system for the backlight module of the present invention comprises: a control circuit 10, at least one thermistor 11, and a light-emitting module 12. The light-emitting module 12 includes a plurality of LEDs (Light Emitting Diode) or CCFLs (Cold Cathode Fluorescent Lamp) and is used to provide brightness for the backlight module. The thermistor 11 detects the temperature of the backlight module and transmits the signals of resistance variation to the control circuit 10. According to the signals of the resistance variation of the thermistor 11, the control circuit 10 uses a PWM method to control the brightness output of the light-emitting module 12 to modulate the temperature of the backlight module so that the temperature rising speed slow down or the temperature gradually descend.

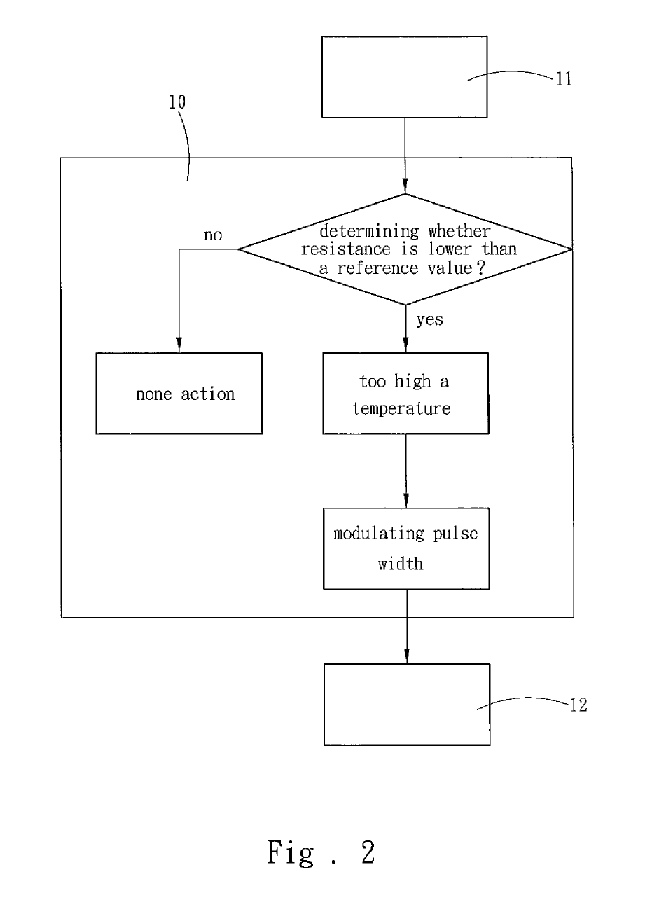

The surface brightness of the backlight module varies with quantity of the light sources of the light-emitting module 12. For example, when the light-emitting module 12 has 64 pieces of LEDs, the surface brightness of the backlight module is 30780 cd/m². After the light passes through the liquid crystal panel, the surface brightness of LCM is 3388 cd/m², which is so high a brightness that sunlight or intense light can no more cover the image of LCD. Refer to FIG. 2. With the increasing turn-on duration of the light sources of the light-emitting module 12, more and more heat generated by the light-emitting module 12 accumulates, and the temperature of LCM thus rises. At the same time, the control circuit 10 receives the signals of the resistance of the thermistor 11. When the resistance of the thermistor 11 is lower than a reference value, it indicates that the backlight module has too high a temperature. Then, the control circuit 10 lowers the brightness of the light-emitting module 12 with a PWM method to decrease the heat generated by the light-emitting module 12 so that the temperature rising speed slow down or the temperature gradually descend. Thereby, the prevent invention can prevent from the malfunction caused by heat accumulation in the light-emitting module 12 and temperature rising in LCM. Further, the present invention can also prevent from the high-temperature-induced performance downgrade and service life decrease of related materials and electronic elements.

When the resistance of the thermistor 11 is higher than the reference value, it indicates that the backlight module does not have too high a temperature or that the temperature has been lowered to a rational range. Thus, the control circuit 10 does not adjust the brightness of the light-emitting module 12 but keeps on providing appropriate power for the light-emitting module 12 via a due pulse width to maintain the brightness of the light-emitting module 12.

Increasing the light source quantity of the light-emitting unit can promote the surface brightness of LCM, but it also generates more heat. The present invention can timely modulate the brightness of the light-emitting module to slow the temperature rising speed or gradually lower the temperature via the detection function of the thermistor and the PWM control of the control circuit. Thereby, the prevent invention can prevent from LCM malfunction caused by heat accumulation in the light-emitting module. Further, the present invention can also prevent from the high-temperature-induced performance downgrade and service life decrease of related materials and electronic elements.

The preferred embodiments described above are only to exemplify the present invention but not to limit the scope of the present invention. Therefore, any equivalent modification or variation according to the spirit of the present invention is to be also included within the scope of the present invention.

What is claimed is:

1. A temperature control system for a backlight module comprising:
a light-emitting module providing brightness for said backlight module;
at least one thermistor used to detect temperature variation of said backlight module; and
a control circuit modulating temperature of said backlight module via receiving signals of resistance variation of said thermistor and controlling brightness output of said light-emitting module.

2. The temperature control system according to claim 1, wherein said light-emitting module includes a plurality of light emitting diodes.

3. The temperature control system according to claim 1, wherein said light-emitting module includes a plurality of cold cathode fluorescent lamps.

4. The temperature control system according to claim 1, wherein said control circuit controls brightness of said light-emitting module with a PWM (Pulse Width Modulation) method.

5. The temperature control system according to claim 1, wherein when resistance of said thermistor is lower than a reference value, said control circuit lowers brightness output of said light-emitting module; when resistance of said thermistor is higher than said reference value, said control circuit does not adjust brightness output of said light-emitting module.
